(19) United States
(12) Patent Application Publication
(10) Pub. No.: US 2026/0217946 A1
(43) Pub. Date: Jul. 30, 2026

(54) RECONFIGURABLE SWCNT FERROELECTRIC FIELD-EFFECT TRANSISTOR ARRAYS

(71) Applicants: Drexel University, Philadelphia, PA (US); Jackson State University, Jackson, MS (US)

(72) Inventors: Yury Gogotsi, Warminster, PA (US); James Broe FitzPatrick, Philadelphia, PA (US); Nihar R. Pradham, Brandon, MS (US)

(21) Appl. No.: 19/460,572

(22) Filed: Jan. 27, 2026

Related U.S. Application Data
(60) Provisional application No. 63/749,921, filed on Jan. 27, 2025.

(51) Int. Cl. C08K 3/14; C08F 14/22; H01G 4/12; H01G 4/18

(52) U.S. Cl. CPC C08K 3/14; C08F 14/22; H01G 4/1209; H01G 4/186; C08K 2201/001; C08K 2201/003

(57) ABSTRACT

A composite, comprising: a polyvinylidene fluoride (PVDF) matrix, the PVDF of the matrix having a crystalline portion that is primarily β-phase in nature; and a plurality of MXene flakes dispersed within the PVDF matrix, at least some of the MXene flakes optionally being monolayer in nature. A capacitor, comprising: a first electrode; a second electrode; and a dielectric layer disposed between the first electrode and the second electrode, the dielectric layer comprising a polyvinylidene fluoride (PVDF) matrix and a plurality of MXene flakes dispersed within the PVDF matrix. A method of delaminating MXene, comprising: dispersing a quantity of MXene into propylene carbonate; and delaminating dispersed MXene so as to give rise to a suspension of MXene flakes in propylene carbonate.

### RELATED APPLICATIONS

The present application claims priority to and the benefit of U.S. patent application No. 63/749,921, “Polymer-MXene Composites In Thin Film Dielectric Capacitors,” filed Jan. 27, 2025. All foregoing applications are incorporated herein by reference in their entireties for any and all purposes.

### TECHNICAL FIELD

The present disclosure relates to the field of MXene materials and to the field of electrical capacitors.

Thin-film capacitors offer a promising energy storage solution due to their rapid charge/discharge rates, cycling stability, and power density. Dielectric polymer films are very attractive for this application as a result of their high breakdown voltage and dielectric permittivity, two factors crucial to determining the maximum energy density of a dielectric. However, many polymer systems still fall short in terms of discharge energy density and efficiency compared to alternative energy storage methods. Accordingly, there is a long-felt need in the art for improved capacitor devices.

### SUMMARY

As described herein, MXenes are delaminated in a green organic solvent to achieve large flake size and polymer compatibility. PVDF composites are produced through non-solvent induced phase separation to tune structure and properties of thin-film dielectric capacitors. MXenes with both mixed and pure chlorine terminations enhance the dielectric properties of PVDF, reaching—in a non-limiting example—energy density above 45 J cm⁻³ and 95% efficiency.

In meeting the described long-felt needs, the present disclosure provides a composite, comprising: a polyvinylidene fluoride (PVDF) matrix, the PVDF of the matrix having a crystalline portion that is primarily β-phase in nature; and a plurality of MXene flakes dispersed within the PVDF matrix, at least some of the MXene flakes optionally being monolayer in nature.

Also provided is a capacitor, comprising: a first electrode; a second electrode; and a dielectric layer disposed between the first electrode and the second electrode, the dielectric layer comprising a polyvinylidene fluoride (PVDF) matrix and a plurality of MXene flakes dispersed within the PVDF matrix.

Further disclosed is a method of delaminating MXene, comprising: dispersing a quantity of MXene into propylene carbonate; and delaminating dispersed MXene so as to give rise to a suspension of MXene flakes in propylene carbonate.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIGS. 1(a)-1(d): (a) SEM image of larger Ti3C2Tx flake, (b) AFM image of several Ti3C2Tx flakes, (c) lateral size distribution of a sample of 60 flakes of Ti3C2Tx delaminated in PC, obtained by analyzing AFM and SEM images and (d) height profile of single flake of Ti3C2Tx by AFM.

FIGS. 2(a)-2(c): Schematic of NIPS process for preparing PVDF-MXene composite membranes. (a) Blending of PVDF and MXene by heated dissolution into propylene carbonate suspension of Ti₃C₂Tₓ, (b) doctor blading of polymer solution onto a glass substrate, and (c) submersion in a non-solvent bath of DI water.

FIGS. 3(a)-3(d): (a) XRD of porous PVDF-MXene samples, (b) Raman spectra of porous pristine PVDF, porous 3 wt % Ti₃C₂Tₓ in PVDF, and PC-delaminated Ti₃C₂Tₓ, (c) full FTIR spectra of porous PVDF-MXene samples and (d) normalized FTIR spectra for porous PVDF-MXene samples at the region of interest for PVDF characterization.

FIGS. 4(a)-4(f): SEM images of the surfaces of (a) porous pristine PVDF, (b) 1 wt % Ti₃C₂Tₓ in porous PVDF, (c) 3 wt % Ti₃C₂Tₓ in porous PVDF, (d) 0.5 wt % Ti₃C₂Cl₂ in porous PVDF, (e) non-porous pristine PVDF, (f) 0.5 wt % Ti₃C₂Tₓ in non-porous PVDF.

FIG. 5: NanoCT analysis of porous 1 wt % Ti₃C₂Tₓ in porous PVDF showing the distribution of MXene within of roughly 0.166 mm³ field of view. Histogram plots the distribution of flake and/or agglomeration sizes.

FIGS. 6(a-c) P-E loops of the three best performing capacitors (C₁, C₂, and C₃) for porous pristine PVDF, 0.5 wt % Ti₃C₂Cl₂ in porous PVDF, and 1 wt % Ti₃C₂Tₓ in porous PVDF, FIGS. 6(d-f) corresponding energy density and efficiency curves for these porous PVDF-MXene films.

FIGS. 7(a)-7(c): (a) Weibull probability distribution plots for nonporous pristine PVDF and 0.5 wt % Ti₃C₂Cl₂ in nonporous PVDF, (b) Weibull plots for porous pristine PVDF, 0.5 wt % Ti₃C₂Cl₂ in porous PVDF, and 1 wt % Ti₃C₂Tₓ in porous PVDF, (c) histogram of energy density for all measured capacitors across the five compositions as indicated on top of each set of data.

FIGS. 8(a)-8(b): Ashby plots compiled from the literature on enhancing PVDF (a) dielectric energy density and (b) discharge efficiency through composite structures with 2D nanofillers: mica, boron nitride nanosheets (BNNS), Ca₂Nb₃O₁₀, MoS₂, previous work with Ti₃C₂Tₓ MXene, compared to the results from this work.

FIGS. 9(a)-9(d): XRD patterns of Ti₃AlC₂ MAX phase and Ti₃C₂Tₓ MXene delaminated in PC. (a) Indexed peaks confirm the structure of MAX and MXene. (b) The (002) peak shifts from 9.4° in MAX to 6.68° in MXene, denoting an increase in d-spacing from 9.4 to 13.2 A. (c) SEM image of unetched Ti₃AlC₂ MAX phase, and d) SEM image of etched multilayer Ti₃C₂Tₓ.

FIGS. 10(a)-10(c): SEM images of LAMS-Ti₃C₂Cl₂ single-layer flakes at (a) lower magnification and (b) higher magnification as well as (c) Raman spectra confirming synthesis of Ti₃C₂Cl₂ and Ti₃C₂Tₓ MXenes with presence of characteristic A_{1g} and E_{g} peaks.

FIGS. 11(a)-11(c): (a) Model of PVDF's α- and β-phase crystalline structures, showing repeating units of —CH₂CF₂— that act as a dipole in the β-phase, (b) schematic of the hydrogen bonding between the β-phase of PVDF and the negatively charged surface of MXene and (c) schematic of well aligned MXene flakes aiding in orientation of the dipoles in β-phase PVDF, leading to a higher dielectric constant.

FIGS. 12(a)-12(f): Additional SEM images. (a) FIB-SEM of P_X_3 cross-section at 550 angle showing network of closed microvoids, (b) SEM image showing agglomeration of several MXene flakes from PC delamination forming one larger structure from restacking over time, (c) cross-sectional SEM image of P_PVDF sample for thickness calculation, (d) cross-sectional SEM of N_Cl_0.5 film for thickness calculation, (e) image of several capacitor samples after fabrication and (f) microscopic image of fabricated capacitor sample with electrode attached for measurement.

FIGS. 13(a)-13(d): (a) P-E loops of N_PVDF samples showing consistent polarization behavior, (b) P-E loops of N_Cl_0.5 samples showing similar polarization with more variability, (c) discharge energy density and efficiency plotted for N_PVDF and (d) discharge energy density and efficiency plotted for N_Cl_0.5 with similar results at a higher breakdown voltage.

FIGS. 14(a)-14(d): (a) Dielectric constant measurements for N_PVDF, (b) dielectric constant measurements for N_Cl_0.5, showing notably higher values with more variability, (c) dielectric loss tangent measured for N_PVDF and (d) dielectric loss tangent measured for N_Cl_0.5.

FIGS. 15(a)-15(f): (a) Dielectric constant measurements for P_PVDF, (b) dielectric constant measurements for P_Cl_0.5, showing similar increase to nonporous films, (c) dielectric constant measurements for P_X_1 with greatly enhanced permittivity, (d) dielectric loss tangent measured for P_PVDF, (e) dielectric loss tangent measured for P_Cl_0.5 and (f) dielectric loss tangent measured for P_X_1.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4.

Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

Any embodiment or aspect provided herein is illustrative only and does not limit the scope of the present disclosure or the appended claims. Any part or parts of any one or more embodiments or aspects can be combined with any part or parts of any one or more other embodiments or aspects.

Polyvinylidene fluoride (PVDF) is a semicrystalline polymer used in thin-film dielectric capacitors because of its inherently high dielectric constant and low loss tangent. Its dielectric constant can be increased by the formation and alignment of its β-phase crystalline structure, which can be facilitated by 2D nanofillers. 2D carbides and nitrides, MXenes, are promising candidates due to their notable dielectric permittivity and ability to increase interfacial polarization, but their mixing is challenging due to weak interfacial interactions and poor dispersibility of MXenes in PVDF. This work explores a novel method for delaminating Ti₃C₂Tₓ MXene directly into organic solvents while maintaining flake size and quality, as well as the use of a non-solvent induced phase separation method for producing both dense and porous PVDF-MXene composite films.

By examining MXenes with both mixed and pure chlorine terminations in PVDF matrices, a deeper understanding of dielectric behavior in these composites is reached, and record values of energy density, exceeding 45 J cm⁻³, with 95% efficiency achieved in thin-film capacitors. The PVDF-MXene composites are also processed using a green and sustainable solvent, propylene carbonate.

### Introduction

Thin-film capacitors offer a promising energy storage solution due to their rapid charge/discharge rates, cycling stability, and power density. Dielectric polymer films are very attractive for this application as a result of their high breakdown voltage and dielectric permittivity, two factors crucial to determining the maximum energy density of a dielectric. However, many polymer systems still fall short in terms of discharge energy density and efficiency compared to alternative energy storage methods.

Polyvinylidene fluoride (PVDF) is a semicrystalline fluoropolymer that has been widely researched for this application due to its inherently high dielectric constant, up to 10 as compared to 2-4 in other polymers, as well as ease of processing and chemical resistance.

Even though pristine PVDF films typically reach a discharge density of 5-10 J cm⁻³, which is much higher than commercially available biaxially oriented polypropylene films at 1-3 J cm⁻³, these values are still low compared to electrochemical capacitors. Several methods can be employed to increase the dielectric permittivity and energy density of PVDF films.

PVDF forms five distinct crystal polymorphs: α, β, γ, δ, and ε, with the β-phase being of particular interest due to its highly polar structure and improved permittivity. While not as energetically favorable to form as the nonpolar a-phase, there has been much research demonstrating the role that processing methods, solvent selection, and nanofiller inclusion can play in increasing the content and orientation of the β-phase. In particular, PVDF dissolved in a highly polar solvent such as propylene carbonate (PC) has been shown to form almost entirely β-phase in its crystalline portion when cast using a non-solvent induced phase separation (NIPS) method. The inclusion of low-dimensional nanofillers can not only improve dielectric permittivity within PVDF and provide interfacial polarization, but also align the polymer's β-phase chains to enhance overall permittivity. Accordingly, 2D nanosheets with greater permittivity and similarly negatively charged surfaces are useful in increasing energy density of PVDF capacitors.

MXenes are a family of 2D transition metal carbides, nitrides, and carbonitrides that have attracted significant attention in recent years due to their unique electronic, chemical, and optical properties. These nanomaterials have a general formula of Mₙ₊₁XₙTₓ with n ranging from 1 to 4, where M is a transition metal (Ti, V, Nb, etc.), X is C and/or N, and Tₓ represents a variety of surface terminations, commonly ═O, —OH, —F, and —Cl.

These mixed surface terminations arise from the synthesis of MXene by etching away A-element layers from the MAX phase precursor using a mix of HF and HCl acids, resulting in hydrophilic nanosheets that are easily dispersed in aqueous solutions.

Challenges such as dispersibility and interfacial compatibility persist with many MXene composites, hindering further progress in creating high performance materials. Hydrophobic polymers show poor compatibility with hydrophilic MXenes, limiting the selection of composite systems. Given PVDF's hydrophobicity, compatibility issues lead to MXene agglomeration, non-uniformity of dispersion, and overall decreased functionality in the composite. To effectively utilize MXene in PVDF composites for this application, lower loadings of nanomaterial are necessary to avoid percolation and leakage current that can greatly decrease the breakdown voltage. This can be difficult to accomplish, given that poor dispersions of MXene in the hydrophobic matrix and weak interfacial interactions can limit the functionality of lower loading composites. Furthermore, most means of blending this nanomaterial with polymers can affect the functionality of the MXene itself.

This disclosure provides, inter alia, a soft delamination method for dispersing MXene into organic solvents without sacrificing flake size or quality. The PC solvent selection not only provides an excellent suspension for stable solutions of MXene but also results in nearly pure β-phase PVDF with enhanced permittivity due to polar interactions during film casting. Porous PVDF-MXene films fabricated through a NIPS process have demonstrated exceptional energy density and record discharge efficiency when examined in dielectric capacitors. Ti₃C₂Tₓ with mixed terminations has been compared to chlorine-terminated Ti₃C₂Cl₂ made through molten salt synthesis. Porous composite films produced in this work significantly outperformed similarly made dense films and resulted in remarkably high efficiency due to the enhanced dielectric permittivity from MXene and structural control from composite processing. Thin-film capacitors made using this method offer a solution to energy storage applications in the next generation of electronics.

### Results and Discussion

### MXene Synthesis and Delamination

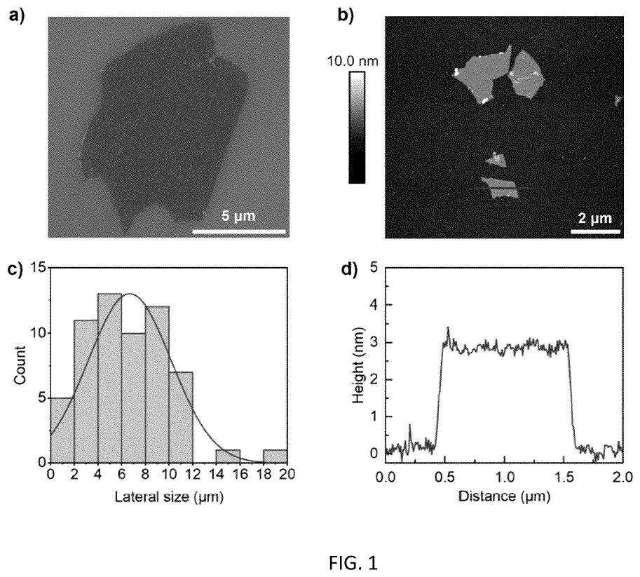

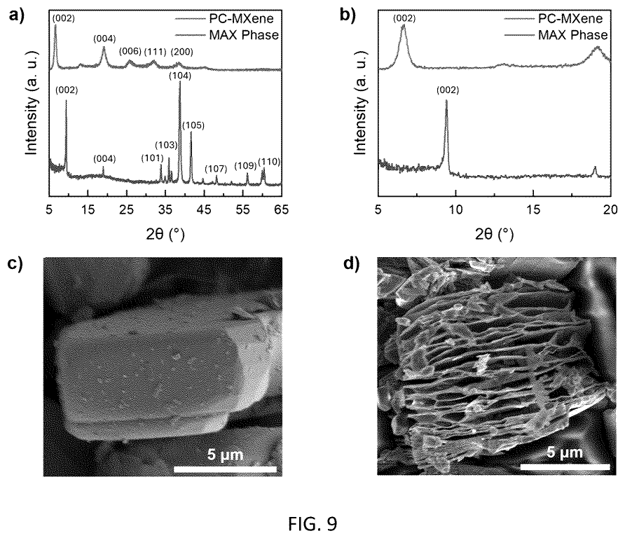

X-ray diffraction (XRD) patterns of the unetched Ti₃AlC₂ MAX phase compared to that of the etched Ti₃C₂Tₓ MXene delaminated in PC are shown in FIGS. 9a and 9b. Indexed peaks for the MAX phase confirm Ti3AlC2 structure with a (002) peak at 9.40°, corresponding to a d-spacing of 9.4 Å. This peak shifts to 6.680 in the delaminated MXene, indicating an increase in d-spacing to 13.2 Å, a typical value for this MXene. Scanning electron microscopy (SEM) confirmed the etching of the A layer from the MAX phase, as seen in the difference between FIG. 1c-d. The multilayer Ti₃C₂Tₓ showed the familiar accordion-like structure, which can be delaminated by sonication, high-shear processing, or chemical intercalation and mechanical agitation. The latter process has been shown to produce larger flakes, which can lead to increased dielectric permittivity in the composite due to the accumulation of charges at the interfaces. To maximize energy density in the PVDF-MXene systems, a softer delamination was performed to disperse single-layer Ti₃C₂Tₓ directly into PC without the need for sonication or excess agitation from solvent exchange. Dispersion of MXene in PC improves polymer compatibility, and provides additional benefits of MXene stability (elimination of oxidation or hydrolysis during storage). For polymer compatibility, PC has the advantage of not only being green and sustainable compared to many commonly used solvents for PVDF, but also facilitating the formation of PVDF's β-phase due to high polarity and solvent interactions. The PC-delaminated Ti₃C₂Tₓ is of higher quality compared to other attempts to disperse MXene into organic solvents.

The standard process for delaminating multilayer Ti₃C₂Tₓ aqueously was slightly adjusted for this work. LiCl was still used as the intercalating agent to swell the layered MXene and residual salts were washed from the solution with deionized (DI) water. The key difference was redispersing the swollen MXene in PC immediately before the bulk of delamination began. Results can vary but delamination tends to occur after 1-2 washes with DI water, due to the agitation from shaking to redisperse the MXene. Sedimented Ti₃C₂Tₓ was redispersed in PC after the second wash with DI water, which required around 10 minutes of mechanical agitation via paint shaker before further centrifugation. The supernatant of PC and water were separated and subsequent redispersions in PC were done by gentle hand shaking, minimizing damage and size reduction of MXene flakes. The yield from this delamination was comparable to that from standard aqueous delamination, and flake size was determined by scanning electron microscopy (SEM) and atomic force microscopy (AFM) as seen in FIG. 1. SEM (FIG. 1a) and AFM (FIG. 1b) imaging show flake morphology as well as larger and smaller flakes. A sample of 60 flakes from both SEM and AFM imaging were measured laterally and found to be almost entirely >1 μm flakes with an average flake size of ~7 μm (FIG. 1c) and an average thickness of around 3 nm (FIG. 1d). This is only slightly thicker than the reported Ti₃C₂Tₓ monolayers with 2.03-2.15 nm thickness, confirming single-layer flakes likely have residual PC on the surface. Given the typical d-spacing seen in vacuum-filtered films, it appears that this residual PC can be removed through filtration or washing. The average lateral size of 7 μm exceeds that of typical MXenes dispersed through ultrasonication, which are often submicron size.

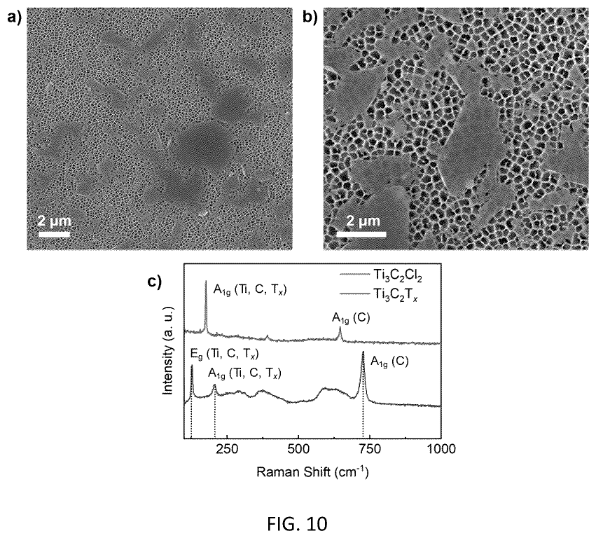

Hydrophobic, pure chlorine-terminated Ti₃C₂Cl₂ MXene was synthesized by a previously reported Lewis acid molten salt etching method with ZnCl₂, and delaminated by Li-ion intercalation in organic solvents and bath sonication. This process yielded smaller flakes that dispersed easily into various organic solvents such as PC. MXene flakes had typical lateral sizes between 1-2 m, as shown in FIGS. 10a-b.

Raman spectra of synthesized Ti₃C₂Cl₂ and Ti₃C₂Tₓ both show the presence of characteristic MXene peaks confirming successfully synthesized structures (FIG. 10c). The conductivity of pure Ti₃C₂Cl₂ films was measured to be ~8,000 S cm⁻¹, comparable to that of typical Ti₃C₂Tₓ MXene.

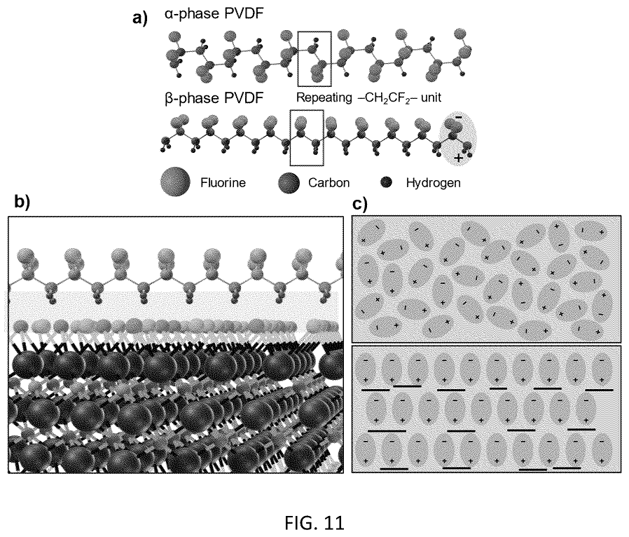

One sample each of porous and nonporous composite film with Ti₃C₂Tₓ was fabricated for this study, and the pure chlorine terminations on the surface of these flakes should facilitate stronger interfacial interactions with the hydrogen groups on the backbone of PVDF chains. PVDF's β-phase is unique in that the hydrogen groups are all present on only one side of the polymer chain, with the fluorine groups polarized to the other side due to the repeating trans bonds in β-phase chains and lack of gauche bonds. FIG. 11 shows a schematic of PVDF crystalline structures (FIG. 11a) and the bonding that occurs between polymer chains and MXene surfaces (FIG. 11b). Hydrogen bonding can take place between these chains and the negatively charged surface groups of MXene sheets, but this effect can be enhanced when the sheets contain pure chlorine terminations compared to mixed terminations. By integrating MXenes with carefully selected chemistry into PVDF composites, nucleation and alignment of the β-phase (FIG. 11c) can be improved to greatly enhance dielectric properties.

### PVDF-MXene Composite Processing and Characterization

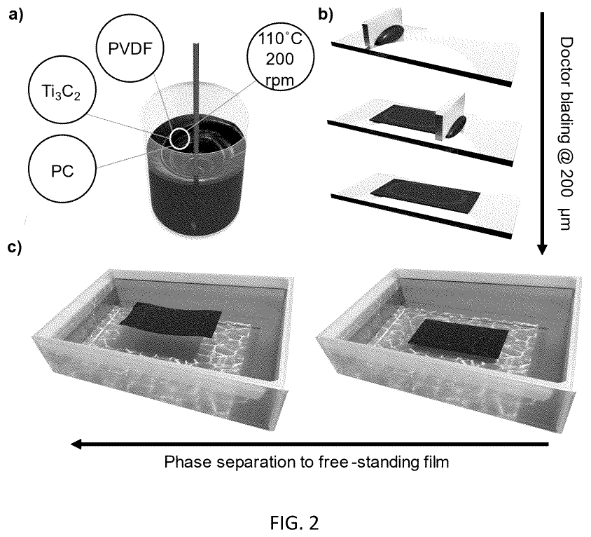

Porous composites of MXene and PVDF polymer were produced through a NIPS process. as shown schematically in FIG. 2. This process involves formulating a dope solution of dissolved polymer in an organic solvent, in this case, PVDF in PC with the addition of MXene, as seen in FIG. 2a. Blade coating the dope solution (FIG. 2b) allows for control of film thickness and aids in orienting MXene flakes and PVDF chains through induced shear stress. Through submersion in a non-solvent bath of DI water (FIG. 2c), two distinct phases of the solution emerge: a polymer-rich phase that sets into a free-standing film and a solvent-rich phase that leaches out of the film, forming a porous network. This process has the advantage of scalability and adaptability, with parameters such as temperature, bath composition, and solids content easily altered to change membrane structure and properties. Dense, non-porous composites were fabricated through the same method, but with an additional heating step before submersion to allow for slow evaporation of most of the residual solvent before fully setting the film.

Using measured concentrations of Ti₃C₂Tₓ in PC, four porous samples of pristine PVDF, 0.1 wt %, 1 wt %, and 3 wt % MXene were produced, denoted as P_PVDF, P_X_0.1, P_X_1, and P_X_3, respectively. Samples were named for whether they are porous (P) or non-porous (N), the termination group of the MXene filler (X for mixed terminations and Cl for pure chlorine terminations), and the content of the MXene filler by mass loading. For comparison, a small amount of Ti₃C₂Cl₂ MXene was dispersed in a porous film at 0.5 wt %, denoted as P_Cl_0.5. Dense, non-porous films of pristine PVDF and Ti₃C₂Cl₂ were fabricated as well, denoted as N_PVDF and N_Cl_0.5, respectively. Table S1 details the structure, MXene surface terminations, and MXene mass and volume loading for each uniquely named sample.

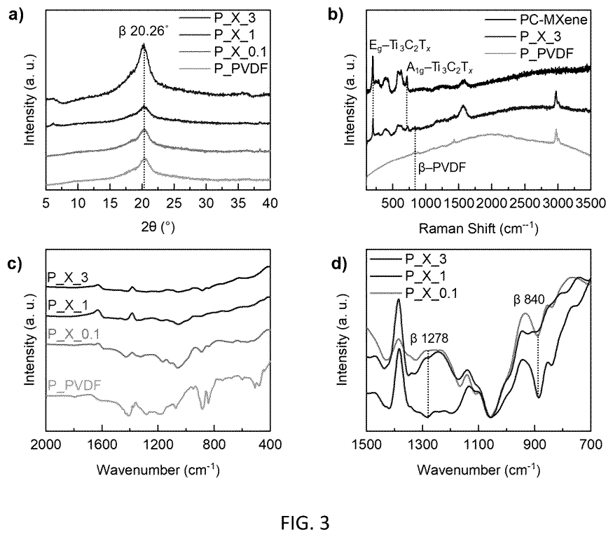

XRD (FIG. 3a) shows the presence of a notable peak around 20.26° across all porous films. This peak is associated with the β-phase of PVDF, compared to two distinct 19.9° and 26.56° peaks for the α-phase and a shoulder peak around 18.5° for both the a- and y-phases. The dominance of the β-phase peak and lack of any other peaks in that area indicate that these PVDF films all exhibit nearly 100% β-phase in their crystalline portions. This is due to strong interactions between the polymer and highly polar solvent, facilitating the formation of polar 3-phase spherulites within the solution. The 002 peak from MXene around 6.7° is broad and has a lower intensity in higher loading samples, indicating that there may be some small agglomerations present within the composite despite a mostly spread out distribution of flakes.

The Raman spectra (FIG. 3b) confirm the presence of the β-phase peak at 840 cm⁻¹ and the lack of α-phase peaks at 795 cm⁻¹ in both P_PVDF and P_X_3. Additionally, characteristic PVDF peaks for CH₂ twisting, scissoring, and stretching modes are observed at 1430 cm⁻¹ and 2900 cm⁻¹ in both pure PVDF and composite samples. The Ti₃C₂Tₓ delaminated in PC was also examined under Raman to confirm peaks are analogous to MXene delaminated in water. These same peaks are present in the spectrum of P_X_3, denoting no chemical changes to the MXene during PC delamination or composite processing through NIPS. The peaks with the largest intensities corresponding to E_{g} (Ti, C, Tₓ) and A_{1g} (C) modes remain at the same wavenumbers in the PC-delaminated sample, indicating comparable surface terminations. FTIR full spectra (FIG. 3c) and normalized spectra in the area of interest (FIG. 3d) confirm the crystalline structure with the presence of β-phase peaks at 1275 cm⁻¹ and 840 cm⁻¹ and lack of notable peaks for α-phase at 765 cm⁻¹ or γ-phase at 1233 cm⁻¹. The full spectra show the IR shielding behavior reported for MXenes, as the relative intensity of each sample examined under identical conditions decreases with increased MXene loading. This shielding behavior present in such low-loading composites can be used in other applications such as thermal management, or heat dissipation within electronic devices.

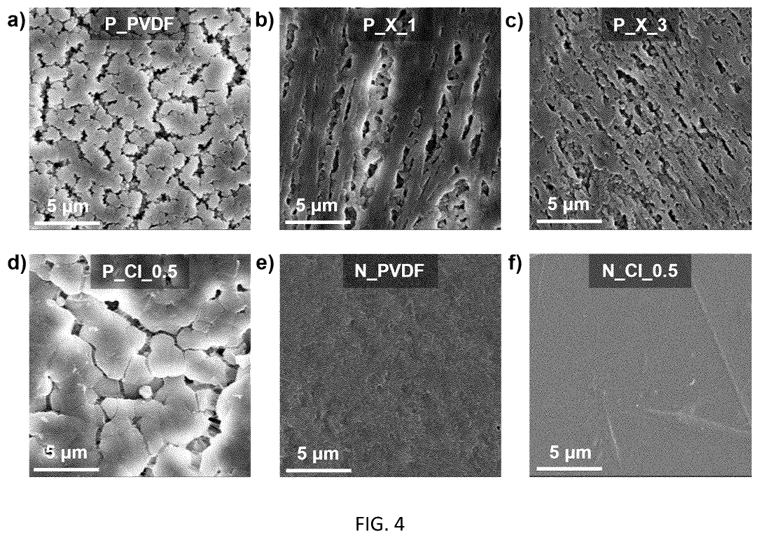

FIG. 4a shows the surface of porous pristine PVDF with a clearly spherulitic structure that forms porous networks. The addition of hydrophilic Ti₃C₂Tₓ MXene facilitated the formation of a tighter pore structure and skin-like surface for the composite films due to enhanced compatibility with the non-solvent and a more rapid mass-exchange rate.

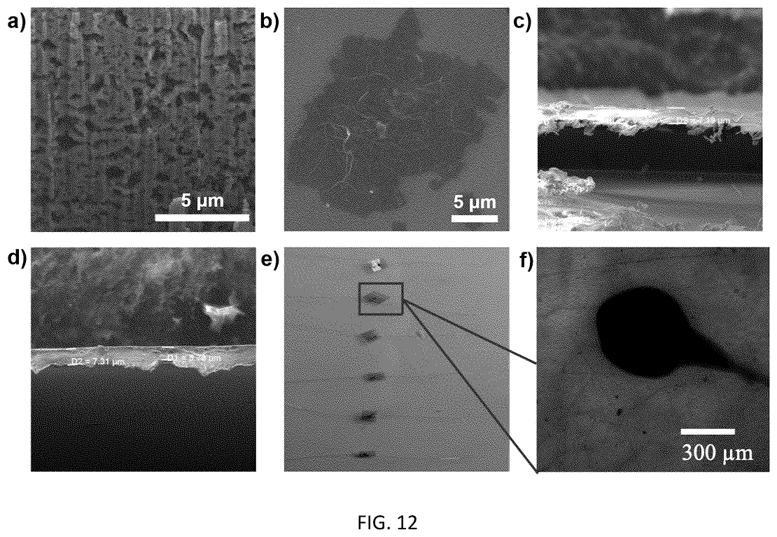

FIG. 4b shows the effect of just 1 wt % inclusion of hydrophilic MXene, leading to faster phase separation and a network of micro- and macrovoids rather than a more open network of slow-forming spherulites. There may be solubility parameters affecting these structures as well, as the MXene may adsorb or attract PC on the surface of flakes, and higher loadings within the dope solution can reduce the available solvent for the dissolution of PVDF. Thus, a higher solids content in the dope can cause faster phase separation and the formation of a more defined pore structure, forming a stronger and more selective membrane. This effect can be seen in the higher-loading porous composite P_X_3 in FIG. 4c with an even tighter and more defined pore structure. An angled cross-section of this sample taken by FIB-SEM can be seen in FIG. 12a, revealing many closed microvoids throughout the film. These voids may aid in enhancing dielectric properties through increased permittivity and interfacial polarization as well. Including a small amount of hydrophobic MXene appears to lead to the formation of larger spherulites seen in FIG. 4d, likely due to a slower phase separation rate. A more hydrophobic solution has poor compatibility with the non-solvent, leading to a slower mass-exchange rate and slow nucleation of larger, independent spherulites. This morphology difference can be seen between FIG. 4e (N_PVDF) and 4f (N_Cl_0.5) as well. The surface of nonporous pristine PVDF was still quite rough, with many divots and partial micropores forming due to the phase separation that occurs at higher temperatures and during final immersion in the non-solvent bath. The surface of nonporous PVDF with hydrophobic MXene integrated into the matrix was much smoother due to slower phase separation kinetics, leading to a more uniform polymer structure.

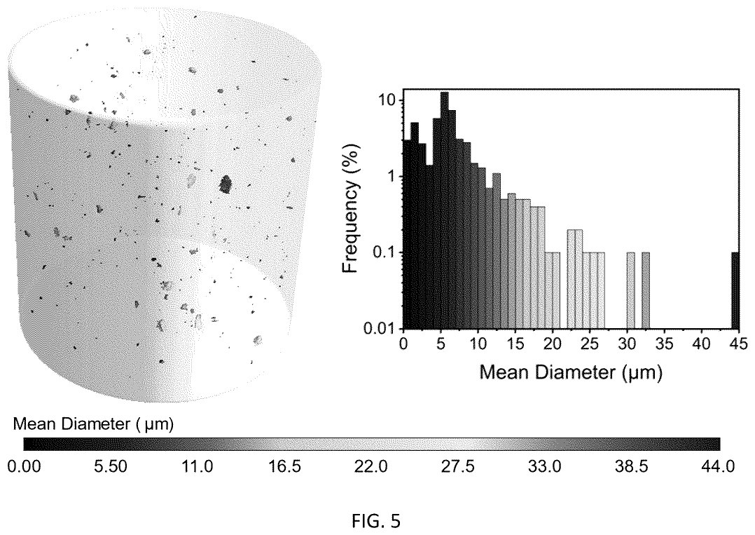

Further structural analysis of composites was performed by micro-computed tomography (Micro-CT), which enables non-destructive visualization of internal structures of the sample in three dimensions. This comprehensive understanding allows for a deeper exploration of how microstructure influences the functionality and performance of the composites. FIG. 5 displays ~0.166 mm³ field of view for P_X_1 scanned with Micro-CT, yielding valuable insights into the quality of discussed samples. The higher X-ray absorption of the MXene enables a clear contrast between the nanofiller and the polymer matrix in Micro-CT. This contrast is crucial for distinguishing the two phases in the composite structure. Mean diameter of flakes and aggregations were plotted in a histogram, showing nearly 99% of particulates smaller than 20 μm, which was roughly the largest single flake size seen in AFM and SEM. The nanofillers exhibit homogeneous dispersion within the polymer matrix with minimal agglomeration. These agglomerations likely occurred while the MXene was stored in liquid solvent, as a larger agglomeration of several flakes can be seen in SEM of flakes deposited directly from solution (FIG. 12b). Despite the agglomerations appearing in this matrix being relatively small and infrequent, their presence highlights the importance of utilizing MXene shortly after synthesis and delamination to minimize restacking and oxidation. The effective dispersion of MXene flakes through the PVDF matrix aids to reduce leakage current from large agglomerations and percolative networks, enhancing dielectric properties.

### Thin-Film Capacitor Testing

The cross-sectional SEM images of the free-standing PVDF-MXene composite films show an average thickness between 5.79 μm and 7.31 μm (FIGS. 12-d), with an average thickness of 6.5 μm considered in all the following measurements for capacitor performance. Capacitors were fabricated using silver as the top and bottom plate as shown in FIGS. 12e-f The area of each fabricated capacitor was calculated to be ~400,000 μm², measured using an optical microscope. Thin Au wires of 0.025 mm diameter were used to connect the metal capacitor plates to the ferroelectric testing setup. Some samples, including non-porous composites of Ti₃C₂Tₓ, were excluded from testing in capacitor applications due to excessive leakage as the conductivity increased with higher loading. P_X_0.1 was excluded as there was no significant change observed in electric conductivity nor dielectric behavior compared to pristine PVDF.

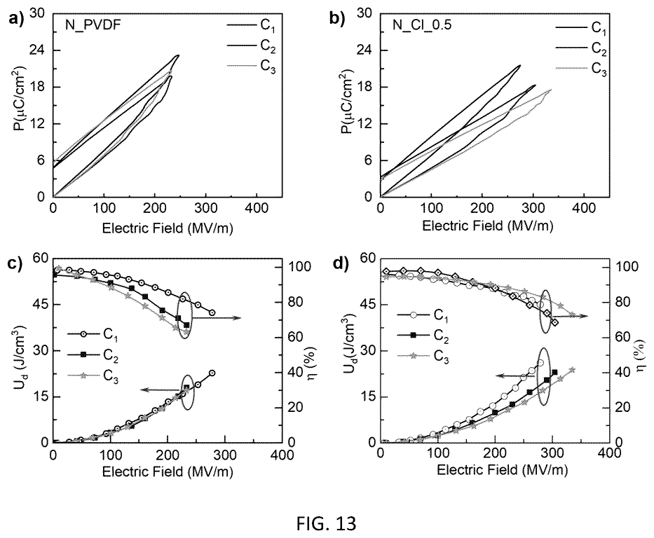

The polarization vs electric field (P-E) loops for N_PVDF and N_Cl_0.5 are shown in FIG. 13. Polarization and energy density of several capacitors were measured and the P-E loops for the three highest performance samples C₁, C₂, and C₃ are plotted. Nonporous pristine PVDF exhibited maximum polarization of 21.2±1.5 μC cm⁻² for capacitors C₁, C₂, and C₃, respectively (FIG. 13a), while the corresponding value for nonporous PVDF with 0.5 wt % Ti₃C₂Cl₂ was 19.2±1.7 μC cm⁻² (FIG. 13b). The polarization values of PVDF were more consistent than those of the PVDF-MXene composite film. The variation of polarization of composite samples could be due to nonuniformity of the MXene distribution in the polymer matrix or variations in flake size and morphology, as the current delamination method for molten salt-etched MXenes produces solutions that contain both single-layer and few-layer MXene.

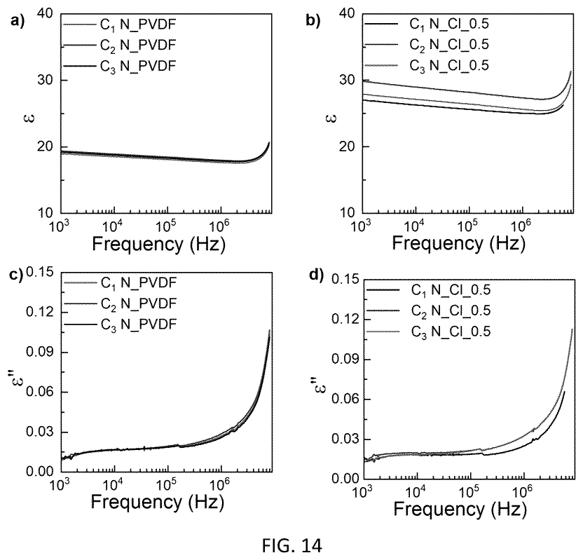

FIGS. 13c-d displays the discharge energy density (U_{d}) extracted from the polarization measurements and efficiency (η) extracted from the discharge and charge energy density plotted as a function of applied electric field for N_PVDF and N_Cl_0.5, respectively. The discharge energy density of N_PVDF at 250 MV m⁻¹ was 18 J cm⁻³, whereas the energy density for N_Cl_0.5 was 22 J cm⁻³ at 290 MV m⁻¹. The efficiency also increased in the composite sample compared to pristine PVDF from 79% to 85% at the average maximum applied electric field. The composite samples showed slightly less hysteresis loss than pristine PVDF capacitors as shown in FIG. 13c. There has been limited research to date on the capacitive energy storage of polymer/MXene composites, but these energy density values reported for these nonporous samples are notably higher than the reported values of PVDF-MXene capacitors. This may be due to the content of β-phase within the PVDF films, greatly enhancing the dielectric constant. As seen in FIG. 14, the dielectric constant of the pristine PVDF is already at the higher end of reported values with a constant of ~19 at 10 kHz. The corresponding dielectric loss in the nonporous PVDF (FIG. 14c) was notably low with a value of 0.017 at 10 kHz. FIG. 14b shows the enhanced dielectric constant of nonporous PVDF with the addition of 0.5 wt % Ti₃C₂Cl₂, reaching a value of ~27 at 10 kHz while still maintaining a low loss tangent of only 0.02 (FIG. 14d). The slow formation of larger spherulites of β-phase PVDF surrounded by more insulating amorphous polymer likely led to greatly enhanced dielectric properties with incredibly low loss tangents, providing an ideal system for dielectric charge storage.

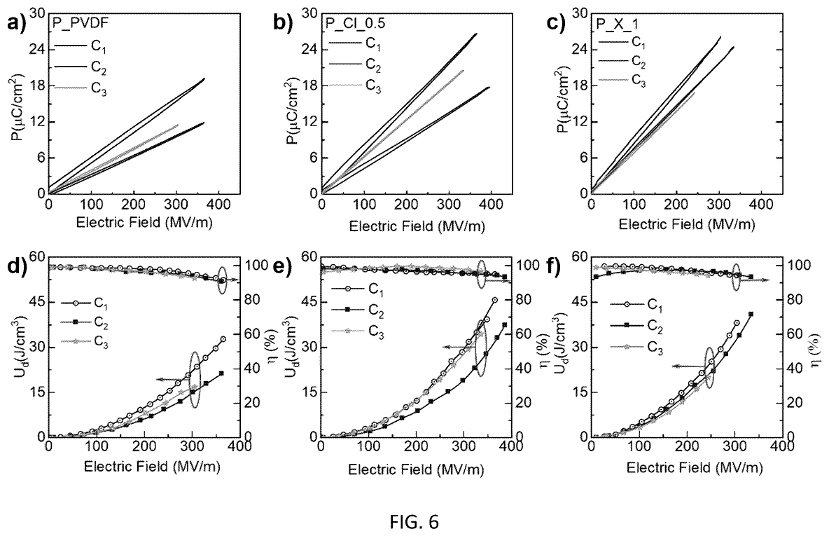

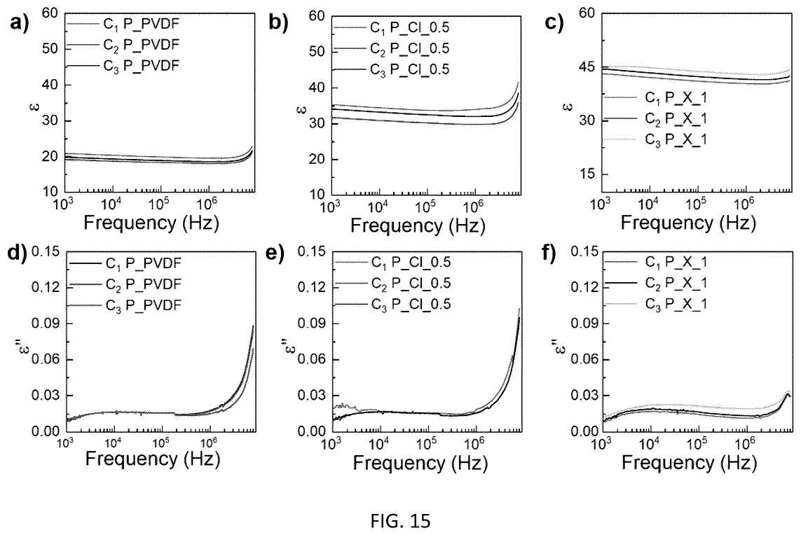

Porous composites of PVDF and MXene yielded better results than nonporous ones, with geometry and measurement parameters between the sample sets being nearly identical. FIG. 6a-c depicts the P-E loops of three capacitor sample sets: porous pristine PVDF, 0.5 wt % Ti₃C₂Cl₂ in porous PVDF, and 1 wt % Ti₃C₂Tₓ in porous PVDF. P_PVDF showed a maximum polarization of 14.2±3.5 μC cm⁻², increasing to 21.6+3.7 μC cm⁻² for P_Cl_0.5. P_X_1 had polarization of 22.5+4.0 μC cm⁻² as shown in FIG. 6c. These results show that the MXene-incorporated porous PVDF nanocomposites had higher polarization values compared to porous pristine PVDF. The dielectric constant for porous pristine PVDF increased only slightly from its nonporous counterpart, from 19 to ~20 at 10 kHz (FIG. 15a), but with a nearly identical loss tangent of 0.017 (FIG. 15d). Porous PVDF with 0.5 wt % Ti₃C₂Cl₂ showed a more significant improvement from the nonporous films, with the dielectric constant increasing from 27 to ~31 (FIG. 15b) while maintaining a lower loss tangent of 0.017 at 10 kHz (FIG. 15e). Porous PVDF with 1 wt % Ti₃C₂Tₓ showed the highest dielectric constant of all measured samples with a value of ~45 at 10 kHz (FIG. 15c), likely due to the increased conductivity and larger lateral size of the flakes. However, dielectric loss in these samples remained even lower than the nonporous composite sample, at a value of 0.019 at 10 kHz FIG. 15f). The dielectric properties of these porous PVDF composites are impressive, and their extremely low loss is an important contributing factor to the efficiency and performance of fabricated capacitors. Porous materials often show both lower dielectric constant and loss due to the presence of low-permittivity air gaps in the matrix. However, the faster phase separation from immediate non-solvent immersion likely led to increased nucleation of the β-phase, while the porous structure minimized charge conduction and energy dissipation.

A feature observed from these results was extremely low hysteresis loss compared to the nonporous PVDF capacitors shown in FIG. 13. The low hysteresis in porous capacitor samples is a contributing factor to the significantly enhanced energy density. The porous matrix has the advantage of high surface area created by the network of pores, allowing for the trapping of charges and leading to increased energy storage capacity compared to nonporous materials. Nanoporous materials are advantageous for electrochemical capacitor systems, owing to the enhanced ion transport in smaller, disordered domains and larger surface area for charge storage, but similar materials have been less explored for dielectric applications. The porosity and increased disorder within these samples may also aid in providing more separation between conductive nanofillers, thus increasing the percolation threshold and allowing for higher loading of nanofillers without excessive leakage current.

The extracted energy density for the P_PVDF, P_Cl_0.5, and P_X_1 are displayed in FIGS. 6d-f. The highest discharge energy density of 32 J cm⁻³ at 365 MV m⁻¹ was measured for the porous PVDF capacitor (FIG. 6d). The 0.5 wt % MXene incorporated porous PVDF capacitors show a significantly enhanced energy density of 46 J cm⁻³ (FIG. 6e) compared to the pure porous PVDF. Similar energy density was measured at ~45 J cm⁻³ for 1 wt % Ti₃C₂Tₓ in porous PVDF and shown in FIG. 6f. These values are significantly higher than reported polymer-based nanocomposites containing MXene nanofiller.

In the PVDF/MXene composites presented in this work, the mixture of MXene in porous media of PVDF acts as a single-layer homogenous system to enhance the energy density. The porous polymer matrix shows ultra-low hysteresis loss which is the key to improved energy density and record efficiency. Incorporation of MXene as a filler further enhanced the energy density without increasing any dielectric loss. These results demonstrate that the careful design of composite structures with MXene filler can significantly enhance both breakdown strength and energy storage capabilities. These homogenous systems could be integrated into heterostructures for even higher performance capacitors. Binary systems of PVDF and MXene as presented in this work can be used as the foundation for more complex composites that outperform many existing capacitors.

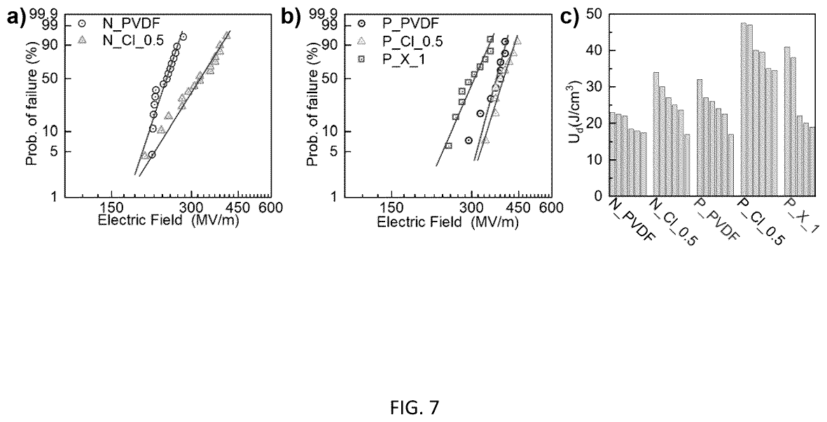

The breakdown strength for each set of samples was measured by increasing the applied voltage on each capacitor and measuring the polarization or current on the sample. The breakdown strength is the minimum voltage that causes a portion of a dielectric film to experience electrical breakdown and become electrically conductive. The Weibull probability distribution predicts the probability of failure and was plotted as a function of the applied electric field where breakdown occurs, presented in FIG. 7. The data points represent the experimental measured values, and solid line shows the Weibull probability fit using Equation 1:

$$P ( E ) = 1 - exp ( - {( \frac{E}{{E}_{B D}} )}^{β} ) \qquad ( 1 )$$

where P is the cumulative probability of failure, E is the electric field at dielectric failure, E_{BD} is the dielectric breakdown field strength (the dielectric strength at 63.2% probability of failure), and β is a shape parameter that defines the film uniformity across the sample. Higher β values correspond to higher quality samples for dielectric capacitors. FIG. 7a shows the Weibull plot of the nonporous PVDF capacitor (blue circles) and the nonporous composite of Ti₃C₂Cl₂ (orange triangles). N PVDF has a breakdown strength of E_{BD}=250 MV m⁻¹ with a β value of 12.4, showing uniform film quality or reliability of the film. The breakdown strength increased to 342 MV m⁻¹ for N_Cl_0.5 with a β value of 7. The lower R value in the composite capacitor suggests less uniformity throughout the film, likely due to the low mass loading of the nanofiller and the variability in flake size and thickness. FIG. 7b depicts the probability of failure as a function of the applied electric field for P_PVDF (blue circle), P_Cl_0.5 (orange triangular), and P_X_1 (green rectangular) composites. The solid lines are the Weibull fit to extract the breakdown strength of the sample. The porous pristine PVDF samples had a breakdown strength of E_{BD}=380 MV m⁻¹ with shape parameter β value of 15 which was much higher than the breakdown strength and β value obtained from the nonporous PVDF sample.

The immediate phase separation involved in producing the porous samples may lead to more uniform films due to faster solidification through the entire thickness of the polymer as it sets. The porous PVDF with 0.5% Ti₃C₂Cl₂ achieved an even higher breakdown strength of E_{BD}=406 MV m⁻¹ with excellent reliability of β=13. This suggests that the conductive MXene nanofiller can increase the breakdown voltage of polymer samples at lower loading. This could be due to excellent interfacial interactions with the chlorine-terminated surfaces of these MXenes. Such interfacial compatibility can lead to a tighter packing of the polymer around the nanofiller, causing a shielding effect that slows the transport of electrons. P_X_1 exhibited a lower breakdown strength of E_{BD}=320 MV m⁻¹, which highlights the more direct effect on film conductivity that mixed termination MXenes can have. The low mass loading of 1% Ti₃C₂Tₓ seems to be nearing the percolation threshold for this system, slightly decreasing the breakdown strength of the film. However, the energy density was similar to the 0.5 wt % Ti₃C₂Cl₂ composite, which is due to the enhanced dielectric strength and interfacial polarization between the higher content of MXene fillers and polymer matrix.

FIG. 7c presents the histogram plot of all measured capacitors across the five compositions N_PVDF, N_Cl_0.5, P_PVDF, P_Cl_0.5, and P_X_1, providing a comprehensive comparison of energy density variations. The data confirms that the porous PVDF with 0.5% Ti₃C₂Cl₂ consistently outperformed other compositions in terms of both energy density and efficiency, while samples with 1% Ti₃C₂Tₓ showed more variability, possibly due to variations in flake size and small agglomerations forming within the matrix. Further exploration into various compositions under 1 wt % loading of mixed termination MXenes could yield more promising results by reducing the impact on the breakdown voltage. Utilizing processing methods to produce porous composites of PVDF and various chemistries of MXene appears to be an auspicious path toward fabricating a new generation of ultra-high-performance capacitors.

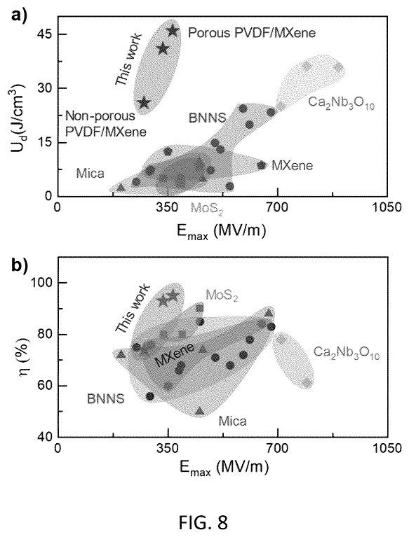

Compared to other systems, this work presents PVDF thin films that show both higher energy density and efficiency as seen in the Ashby plots in FIG. 8. The NIPS process for integrating both PC-delaminated Ti₃C₂Tₓ and pure chlorine terminated Ti₃C₂Cl₂ has produced capacitors that outperform similar polymer systems with nanofiller of mica, Ca₂Nb₃O₁₀, boron nitride nanosheets, MoS₂, and Ti₃C₂Tₓ MXene. This work demonstrates that energy density and efficiency can be significantly improved even without substantial enhancement of the breakdown voltage of the polymer film.

### CONCLUSIONS

This study presents a method for producing high-performance PVDF/MXene composites with improved dielectric properties at low loadings of MXene. Soft delamination of multilayer MXene directly into a green solvent such as propylene carbonate yields stable colloidal solutions of large MXene flakes with enhanced compatibility with PVDF. The combination of a polar PC solvent and 2D MXene nanofiller facilitate the formation and alignment of near pure β-phase crystalline structure, greatly enhancing dielectric properties. The NIPS process for fabricating polymer membranes is highly advantageous for composite processing due to adaptability and scalability. This process can produce both dense and porous films, the latter of which show promising results as thin film capacitors. The incorporation of MXene into both nonporous and porous PVDF films significantly enhances the dielectric and energy storage properties. The addition of only 0.5 wt % Ti₃C₂Cl₂ MXene, especially in porous PVDF, resulted in a higher energy density, improved efficiency, and increased breakdown strength compared to pure PVDF and higher MXene-loaded samples. The optimal combination of low MXene content with excellent interfacial compatibility and porosity of the polymer led to the best performance, achieving an energy density of 46 J cm-1 and a breakdown strength of 406 MV m⁻¹. Higher loading of mixed acid-etched Ti₃C₂Tₓ MXene content at 1 wt % led to reduced breakdown voltage but comparable overall performance.

It should be understood that although Ti₃C₂Tₓ MXene is used herein to illustrate the disclosure technology, the disclosed technology is not limited to Ti₃C₂Tₓ MXenes, as the disclosed technology can be used with essentially any MXene material.

MXenes can be compositions comprising at least one layer having first and second surfaces, each layer comprising
a substantially two-dimensional array of crystal cells,
each crystal cell having an empirical formula of Mₙ₊₁Xₙ, such that each X is positioned within an octahedral array of M,
wherein M is at least one Group IIIB, IVB, VB, or VIB metal;
wherein each X is C and/or N (i.e., stoichiometrically X=CxNy, including where x+y=1); and
n=1, 2, or 3.

MXene materials can also be a substantially two-dimensional array of crystal cells,
each crystal cell having an empirical formula of M′₂M″ₙ~Xₙ₊₁, such that each X is positioned within an octahedral array of M′ and M″;
wherein M′ and M″ each comprise different Group IIIB, IVB, VB, or VIB metals;
each X is C, N, or a combination thereof,
n=1 or 2; and wherein
the M′ atoms are substantially present as two-dimensional outer arrays of atoms within the two-dimensional array of crystal cells;
the M″ atoms are substantially present as two-dimensional inner arrays of atoms within the two-dimensional array of crystal cells; and
the two dimensional inner arrays of M″ atoms are sandwiched between the two-dimensional outer arrays of M′ atoms within the two-dimensional array of crystal cells.

In independent embodiments, M′ is or comprises Sc, Cr, Hf, Mo, Ti, V, Zr, of a combination of two or more thereof, and/or M′ is or comprises Ti, V, Cr, Mo, of a combination of two or more thereof, provided that both M′ and M″ do not contain the same metals.

In other independent embodiments, M″ is or comprises Ti, V, Nb, Ta, of a combination of two or more thereof.

In still other independent, M′₂M″ₙXₙ₊₁, (n=1) is or comprises Mo₂TiC₂, Mo₂VC₂, Mo₂TaC₂, Mo₂NbC₂, Nb₂VC₂, Ta₂TiC₂, Ta₂VC₂, Nb₂TiC₂, Cr₂TiC₂, Cr₂VC₂, Cr₂TaC₂, Cr₂NbC₂, Ti₂NbC₂, Ti₂TaC₂, V₂TaC₂, or V₂TiC₂. M′₂M″ₙXₙ₊₁ (n=2) is or comprises Mo₂Ti₂C₃, Mo₂V₂C₃, Mo₂Nb₂C₃, Mo₂Ta₂C₃, Cr₂Ti₂C₃, Cr₂V₂C₃, Cr₂Nb₂C₃, Cr₂Ta₂C₃, Nb₂Ta₂C₃, Ti₂Nb₂C₃, Ti₂Ta₂C₃, V₂Ta₂C₃, V₂Nb₂C₃, or V₂Ti₂C₃.

The surface of these crystalline compositions may also be characterized as having surface terminations bonded to the outer arrays of atoms, the surface terminations comprising alkoxide, carboxylate, halide, hydroxide, hydride, oxide, sub-oxide, nitride, sub-nitride, sulfide, thiol, or a combination or subset thereof.

The crystalline compositions may be separately described in terms of an ordered or disordered state, with respect to M′ and M.″ Independent embodiments of the ordered state include those where: (a) the two-dimensional outer arrays of atoms contain 80 atom % or more, 85 atom % or more, 90 atom % or more, 95 atom % or more, 98 atom % or more, or substantially all M′ atoms, the balance to 100 atom % being M″ atoms; and (b) the two-dimensional inner arrays of atoms contain 80 atom % or more, 85 atom % or more, 90 atom % or more, 95 atom % or more, 98 atom % or more, or substantially all M″ atoms, the balance to 100 atom % being M′ atoms; within the two-dimensional array of crystal cells.

Example MXene materials suitable for the disclosed technology are described, for example in United States patents and/or patent applications U.S. Pat. Nos. 12,431,258; 11,773,480; 11,691,878; 11,554,961; 11,470,424; 11,456,527; 11,312,631; 11,278,862; 11,202,398; US 2021/0261415; U.S. Pat. Nos. 10,971,733; 10,948,446; 10,886,525; US 2020/0405165; U.S. Pat. Nos. 10,720,644; 10,538,431; US 2019/0044185; US 2017/0294546; and US 2014/0162130, all of which are incorporated herein by their entireties for any and all purposes.

### Experimental Methods

Synthesis of Ti₃C₂Tₓ MXene: MXene Ti₃C₂Tₓ was synthesized by selective wet-chemical etching of Al from MAX phase Ti₃AlC₂ produced by Carbon Ukraine, Ltd, with particle size <40 μm. Ti₃C₂Cl₂ was synthesized by molten salt etching of the same MAX phase precursor. HCl-washed dry Ti₃AlC₂ MAX phase (1 g) was immersed in etchant (20 mL) and stirred at 300 rpm at 35° C. for 24 h. The etching solution contains a mixture of HF (48-51 wt %, Acros Organics), HCl (37 wt %, Fisher Scientific), and DI water with a volumetric ratio of HF:HCl:H₂O equal to 1:6:3. Multilayered Ti₃C₂Tₓ MXenes were intercalated with lithium chloride (LiCl, 99%, Alfa Aesar) using 1 g of LiCl per 1 g of Ti₃AlC₂ MAX, dissolved in DI water (50 mL), and stirred at 300 rpm at room temperature for 24 h. The resulting solution was washed with DI water and centrifuged at 3500 rpm for 5 min, followed by another DI water wash and centrifugation cycle. The supernatant was discarded, and the washed MXene was redispersed in propylene carbonate (99 wt %, Sigma-Aldrich) by mechanical agitation in a paint shaker for 10 minutes. The dark supernatant was collected and further cycles of redispersion in PC and mechanical agitation were repeated until a sufficient yield (30-50%) was reached.

Synthesis of Ti₃C₂Cl₂ MXene: For the synthesis of Ti₃C₂Cl₂ MXene, a molten salt etching process with anhydrous ZnCl₂ (Sigma Aldrich, >99%) as the etchant. ZnCl₂ and Ti₃AlC₂ MAX phase were mixed in a 1:8 mass ratio inside an Ar-filled glove box to prevent moisture contamination. The mixture was transferred to an alumina crucible and heated to 640° C. at a rate of 5° C. min⁻¹ under constant Ar flow (5 SCCM) for 4 hours. Following the reaction, the product was acid-washed in 12M HCl for 6 hours to remove unreacted ZnCl₂ and Zn residues and then centrifuged at 1,500 rcf for 5 minutes for several cycles with DI water to ensure thorough washing. The collected multilayer Ti₃C₂Cl₂ MXene was dried via vacuum filtration and transferred to a vacuum furnace for further drying at 45° C. for 48 hours to remove surface adsorbed water. The completely dried MXene powders were transferred into the glovebox for future use. Delamination was achieved by intercalating Li⁺ ions through the dissolution of anhydrous LiCl (1.2 g, Thermal Scientific Chemicals, 99.0%) in anhydrous dimethyl sulfoxide (DMSO, 10 mL, Sigma Aldrich, >99.9%) within a 20 mL glass vial inside an Ar-filled glove box. Subsequently, multilayer LAMS-Ti₃C₂Cl₂ (3 g) was added to the solution and stirred at 1,000 rpm for 72 hours to facilitate intercalation. The intercalated MXene was then washed twice with anhydrous tetrahydrofuran (THF, 10 mL, Sigma Aldrich, ≥99.9%), followed by additional washes with anhydrous N-methylformamide (NMF, Sigma Aldrich, >99.9%) at 1,500 rcf for 5 minutes until swelling was observed. The swelled MXene was subsequently removed from the glovebox and dispersed into anhydrous propylene carbonate (45 mL). The dispersion was then subjected to bath sonication (Branson 2501 Ultrasonic Cleaner, 40 kHz) for 30 minutes, followed by centrifugation at 250 rcf for 5 minutes to obtain a stable colloidal suspension of delaminated MXene. To further concentrate the delaminated MXene, the suspension was centrifuged at 11,200 rcf for 10 minutes.

Fabrication of PVDF-MXene Composite Films: Composites were fabricated by dissolving PVDF into solutions of MXene in PC. Dry PVDF powder (15 g, average M_{W}~534,000, Sigma-Aldrich) was weighed out in a glass jar and a set mass of the PC-MXene solution was then added. The glass jar was placed in a bath of mineral oil at 110° C. to ensure the removal of any excess water and blended with an overhead stirrer at ~200 rpm for 4-5 h to complete dissolution of the PVDF. The resultant polymer solution was kept heated until ready to be cast into films, as the PVDF will slowly phase out of solution at lower temperatures. The solution was deposited onto a glass slide and blade coated at a thickness of 200 μm before submersion into a non-solvent bath of deionized water for at least 5 minutes to leach miscible PC out of the solution and create a free-standing film. This casting process is referred to as non-solvent induced phase separation (NIPS) and can be used to fabricate polymer membranes. The free-standing films were removed from the water bath after 5-10 minutes to ensure solvent removal and left to dry at room temperature overnight. Dense, nonporous films were cast through a similar method, but doctor-bladed solutions were left in air on a heated glass substrate at 150° C. for 2 hours before non-solvent immersion. The resulting membranes were then studied for structure and material properties, and finally fabricated into thin film capacitors.

Atomic Force Microscopy: AFM images were taken with a Bruker Dimension Icon microscope under ambient conditions, operating in Tapping Mode and using TESPA-V2 tips with spring constant, k=42 N m⁻¹. Images were captured at a scan rate of 1 Hz with 1024 lines per image. The statistical analysis was performed on 60 individual Ti₃C₂Tₓ flakes and the results were fitted by using a lognormal distribution.

Scanning Electron Microscopy: SEM was performed using a Thermo Fisher Apreo 2S Lo Vac scanning electron microscope at an operating voltage of 10 kV and beam current of 0.20 nA. Images were captured using a secondary electron (SE) detector at magnifications from 120× to 50,000×. All samples were mounted on aluminum stubs with carbon tape. Non-conductive samples were sputter coated with a Pt/Pd layer using a Cressington Sputter Coater 208HR to deposit a 4-5 nm layer of conductive coating.

Focused ion beam-SEM was performed using a Tescan S8000X Xe plasma FIB-SEM at an operating voltage of 5 kV and beam current of 0.10 nA. FIB etching was done at a 550 angle using Xe plasma first at 10 nA and then at 1 nA for polishing. A combination of secondary electron (SE) and backscattered electron (BSE) detectors were used to capture images at magnifications from 120× to 100,000×.

X-Ray computed tomography: Micro-CT analysis was conducted using a Zeiss Versa 620 system at the Materials Characterization Core of Drexel University. The system operated at 50 kV and 4.5 W, utilizing a 20× objective to achieve a resolution of 0.6 μm. The sample was scanned at room temperature with 3000 projections, without the use of any filters. Images were processed using Zeiss XRM Reconstructor software, including center shift adjustments and beam hardening to ensure precise imaging. Further image enhancement was carried out using Gaussian filtering to improve the quality. Segmentation and quantitative analysis were performed with ORS Dragonfly Pro software, employing a thresholding method refined by manual adjustments.

X-Ray Diffraction: Structural analysis was done using a Rigaku MiniFlex system at 40 kV and 15 mA with Cu Kα radiation. Samples were scanned from 3 to 650 with a step size of 0.020 and a scan speed of 4° min⁻¹. Both aqueous Ti₃AlC₂ MAX phase and Ti₃C₂Tₓ MXene suspended in PC were dried into films or powder by vacuum-assisted filtration. PVDF and composite films were cut to size and secured with Kaptan tape.

Fourier Transform Infrared Spectroscopy: The FTIR was recorded using the KBr method. 0.001 g of each sample was mixed with 0.2 g of KBr powder (Sigma Aldrich, 99.99% anhydrous) followed by manual grinding in with agate mortar and pestle and pressed into pellets under 6 metric tons using hydraulic press (Carver™) and dry pellet pressing die set (MSE Supplies). Plain KBr pellet is measured as background and baseline correction is applied (concave rubber band correction, 6 iterations, 12 baseline points) with 25-point smoothing. The resolution is 4 cm⁻¹ with 14 scans in total. All obtained data was normalized so the sample's highest transmittance has the same value in each sample, resulting in arbitrary units (a. u.) of measurement.

Raman Spectroscopy: Inverted reflection mode Renishaw InVia spectrometer was used to collect Raman data using a 785 nm laser with a 1200 line/mm grating and 63× (NA=0.7) objective. The acquisition time was 30 seconds, and the laser power was 3.59 mW to avoid sample degradation. The measurement was done using the free-standing films of PVDF-MXene and vacuum-filtered pristine MXene films.

Dielectric Measurements: The free-standing films were cut into small pieces and conductive silver paste was used to make electrodes at both sides. The average area of the electrodes of the capacitors varied between 300,000-400,000 mm². The dielectric properties of films were measured at room temperature by a HIOKI (3522) LCR tester with sweeping frequency from 4 Hz to 7 MHz.

Capacitor Testing: Measurements of polarization (P-E loop) and breakdown voltage were carried out under ambient conditions using Radiant Technology Precession II Ferroelectric Tester with a High voltage (10 kV) power source.

### Polymer-MXene Composites in Thin Film Dielectric Capacitors

TABLE S1
Details on structure, surface terminations, and
MXene mass loading for each sample in this work.

| | | | Mass | Volume |
|---|---|---|---|---|
| Sample | Structure | Surface Terminations | Loading (%) | Loading (%) |
| N_PVDF | Non-porous | N/A | 0 | 0 |
| N_Cl_0.5 | Non-porous | —Cl | 0.5 | 0.12 |
| P_PVDF | Porous | N/A | 0 | 0 |
| P_X_0.1 | Porous | —O, —F, —OH, —Cl | 0.1 | 0.02 |
| P_X_1 | Porous | —O, —F, —OH, —Cl | 1 | 0.24 |
| P_X_3 | Porous | —O, —F, —OH, —Cl | 3 | 0.71 |
| P_Cl_0.5 | Porous | —Cl | 0.5 | 0.12 |

It should be noted that surface terminations of mixed acid-etched Ti₃C₂Tₓ tend to primarily contain O and F groups, with more limited OH groups and occasional Cl.^{[1,2]}

### Aspects

The following Aspects are illustrative only and do not limit the scope of the present disclosure or the appended claims. Any part or parts of any one or more Aspects can be combined with any part or parts of any one or more other Aspects.
Aspect 1. A composite, comprising: a polyvinylidene fluoride (PVDF) matrix, the PVDF of the matrix having a crystalline portion that is primarily β-phase in nature; and a plurality of MXene flakes dispersed within the PVDF matrix, at least some of the MXene flakes optionally being monolayer in nature.
Aspect 2. The composite of Aspect 1, wherein the MXene flakes are present at from about 0.1 wt % to about 10 wt % of the weight of the MXene flakes and the PVDF matrix.
Aspect 3. The composite of Aspect 2, wherein the MXene flakes are present at from about 1 wt % to about 3 wt % of the weight of the MXene flakes and the PVDF matrix.
Aspect 4. The composite of any one of Aspects 1-3, wherein the composite is characterized as being porous. The composite can be, for instance, characterized as a porous network.
Aspect 5. The composite of any one of Aspects 1-4, wherein the crystalline portion of the PVDF is greater than about 90% β-phase in nature. The crystalline portion of the PVDF can be, for instance, greater than about 91% β-phase in nature, greater than about 92% β-phase in nature, greater than about 93% β-phase in nature, greater than about 94% 3-phase in nature, greater than about 95% β-phase in nature, greater than about 96% β-phase in nature, greater than about 97% β-phase in nature, greater than about 98% β-phase in nature, or even greater than about 99% β-phase in nature, in some instances.
Aspect 6. The composite of any one of Aspects 1-5, wherein the majority of the MXene flakes are monolayer in nature.
Aspect 7. The composite of any one of Aspects 1-6, wherein the MXene flakes comprise Ti₃C₂Tₓ MXene. It should be understood, however, that other MXenes besides Ti₃C₂Tₓ MXene are suitable and can be used in the disclosed technology, as Ti₃C₂Tₓ MXene is an exemplary, non-limiting MXene. Other example MXenes include, for example, the MXenes described in U.S. Pat. No. 9,193,585.
Aspect 8. The composite of Aspect 7, wherein the MXene flakes comprise chlorine terminations. An exemplary such MXene is Ti₃C₂Tₓ MXene, in which Tₓ are chlorine terminations.
Aspect 9. The composite of any one of Aspects 1-8, wherein 99% of the MXene flakes (by number-average) have a cross-sectional dimension of less than 20 μm. In some instances, 98% of the MXene flakes (by number-average) have a cross-sectional dimension of less than 20 μm; in some instances, 97% of the MXene flakes (by number-average) have a cross-sectional dimension of less than 20 μm; in some instances, 96% of the MXene flakes (by number-average) have a cross-sectional dimension of less than 20 μm; in some instances, 95% of the MXene flakes (by number-average) have a cross-sectional dimension of less than 20 μm.

In some instances, 99% of the MXene flakes (by number-average) have a cross-sectional dimension of less than 15 μm. In some instances, 98% of the MXene flakes (by number-average) have a cross-sectional dimension of less than 15 μm; in some instances, 97% of the MXene flakes (by number-average) have a cross-sectional dimension of less than 15 μm; in some instances, 96% of the MXene flakes (by number-average) have a cross-sectional dimension of less than 15 μm; in some instances, 95% of the MXene flakes (by number-average) have a cross-sectional dimension of less than 15 μm.

In some instances, 99% of the MXene flakes (by number-average) have a cross-sectional dimension of less than 10 μm. In some instances, 98% of the MXene flakes (by number-average) have a cross-sectional dimension of less than 10 μm; in some instances, 97% of the MXene flakes (by number-average) have a cross-sectional dimension of less than 10 μm; in some instances, 96% of the MXene flakes (by number-average) have a cross-sectional dimension of less than 10 μm; in some instances, 95% of the MXene flakes (by number-average) have a cross-sectional dimension of less than 10 μm.

In some instances, 99% of the MXene flakes (by number-average) have a cross-sectional dimension of less than 8 μm. In some instances, 98% of the MXene flakes (by number-average) have a cross-sectional dimension of less than 8 μm; in some instances, 97% of the MXene flakes (by number-average) have a cross-sectional dimension of less than 8 μm; in some instances, 96% of the MXene flakes (by number-average) have a cross-sectional dimension of less than 8 μm; in some instances, 95% of the MXene flakes (by number-average) have a cross-sectional dimension of less than 8 μm.
Aspect 10. The composite of any one of Aspects 1-9, wherein the composite is characterized as a free-standing film. A film can have a thickness in the range of, for example, from about 3 to about 10 m, including subranges of about 3-4 μm; about 3.5-4.5 μm; about 4-5 μm; about 4.5-5.5 μm; about 5-6 μm; about 5.5-6.5 μm; about 6-7 μm; about 6.5-7.5 μm; about 7-8 μm; about 7.5-8.5 μm; about 8-9 μm; about 8.5-9.5 μm; about 9-10 μm; about 3-6 μm; and about 6-10 μm.
Aspect 11. A capacitor, comprising: a first electrode; a second electrode; and a dielectric layer disposed between the first electrode and the second electrode, the dielectric layer comprising a polyvinylidene fluoride (PVDF) matrix and a plurality of MXene flakes dispersed within the PVDF matrix.
Aspect 12. The capacitor of Aspect 11, wherein the PVDF matrix comprises a crystalline portion that is primarily β-phase in nature. As described elsewhere herein, the crystalline portion of the PVDF can be greater than about 90% β-phase in nature. The crystalline portion of the PVDF can be, for instance, greater than about 91% β-phase in nature, greater than about 92% β-phase in nature, greater than about 93% β-phase in nature, greater than about 94% β-phase in nature, greater than about 95% β-phase in nature, greater than about 96% β-phase in nature, greater than about 97% β-phase in nature, greater than about 98% β-phase in nature, or even greater than about 99% β-phase in nature, in some instances.
Aspect 13. The capacitor of any one of Aspects 11-12, wherein the dielectric layer is porous. The dielectric layer can, in some instances, be characterized as a porous network.
Aspect 14. The capacitor of any one of Aspects 11-13, wherein the MXene flakes comprise Ti₃C₂Tₓ MXene.
Aspect 15. The capacitor of any one of Aspects 11-14, wherein the MXene flakes comprise chlorine terminations. An exemplary such MXene is Ti₃C₂Tₓ MXene, in which Tₓ are chlorine terminations.
Aspect 16. The capacitor of any one of Aspects 11-15, wherein the MXene flakes are present at from about 0.1 wt % to about 10 wt % of the weight of the MXene flakes and the PVDF matrix, including sub-ranges of about 0.1-0.5 wt %; about 0.5-1.0 wt %; about 1.0-1.5 wt %; about 1.5-2.0 wt %; about 2.0-3.0 wt %; about 3.0-4.0 wt %; about 4.0-5.0 wt %; about 5.0-6.5 wt %; about 6.5-8.0 wt %; and about 8.0-10 wt %.
Aspect 17. A method of delaminating MXene, comprising: dispersing a quantity of MXene into propylene carbonate; and delaminating dispersed MXene so as to give rise to a suspension of MXene flakes in propylene carbonate.
Aspect 18. The method of Aspect 17, wherein delaminating comprises any one or more of agitating and sonicating. Agitating can be effected by, for example, any one or more of manually agitating, shaking, vortexing, tumbling, rotating.
Aspect 19. The method of any one of Aspects 17-18, wherein the MXene comprises Ti₃C₂Tₓ.
Aspect 20. The method of any one of Aspects 17-19, wherein the MXene flakes comprise chlorine terminations. An exemplary such MXene is Ti₃C₂Tₓ MXene, in which TX are chlorine terminations.

What is claimed:

1. A composite, comprising:
a polyvinylidene fluoride (PVDF) matrix,
the PVDF of the matrix having a crystalline portion that is primarily β-phase in nature; and
a plurality of MXene flakes dispersed within the PVDF matrix,
at least some of the MXene flakes optionally being monolayer in nature.

2. The composite of claim 1, wherein the MXene flakes are present at from about 0.1 wt % to about 10 wt % of the weight of the MXene flakes and the PVDF matrix.

3. The composite of claim 2, wherein the MXene flakes are present at from about 1 wt % to about 3 wt % of the weight of the MXene flakes and the PVDF matrix.

4. The composite of claim 1, wherein the composite is characterized as being porous.

5. The composite of claim 1, wherein the crystalline portion of the PVDF is greater than about 90% β-phase in nature.

6. The composite of claim 1, wherein the majority of the MXene flakes are monolayer in nature.

7. The composite of claim 1, wherein the MXene flakes comprise Ti₃C₂Tₓ MXene.

8. The composite of claim 7, wherein the MXene flakes comprise chlorine terminations.

9. The composite of claim 1, wherein 99% of the MXene flakes have a cross-sectional dimension of less than 20 μm.

10. The composite of claim 1, wherein the composite is characterized as a free-standing film.

11. A capacitor, comprising:
a first electrode;
a second electrode; and
a dielectric layer disposed between the first electrode and the second electrode,
the dielectric layer comprising a polyvinylidene fluoride (PVDF) matrix and a plurality of MXene flakes dispersed within the PVDF matrix.

12. The capacitor of claim 11, wherein the PVDF matrix comprises a crystalline portion that is primarily β-phase in nature.

13. The capacitor of claim 11, wherein the dielectric layer is porous.

14. The capacitor of claim 11, wherein the MXene flakes comprise Ti₃C₂Tₓ MXene.

15. The capacitor of claim 11, wherein the MXene flakes comprise chlorine terminations.

16. The capacitor of claim 11, wherein the MXene flakes are present at from about 0.1 wt % to about 10 wt % of the weight of the MXene flakes and the PVDF matrix.

17. A method of delaminating MXene, comprising:
dispersing a quantity of MXene into propylene carbonate; and
delaminating dispersed MXene so as to give rise to a suspension of MXene flakes in propylene carbonate.

18. The method of claim 17, wherein delaminating comprises any one or more of agitating and sonicating.

19. The method of claim 17, wherein the MXene comprises Ti₃C₂Tₓ.

20. The method of claim 17, wherein the MXene flakes comprise chlorine terminations.
